(19) United States
(12) Patent Application Publication
(10) Pub. No.: US 2020/0047302 A1
(43) Pub. Date: Feb. 13, 2020

(54) MACHINE SYSTEM AND CONTROL METHOD

(71) Applicant: KOMATSU INDUSTRIES CORPORATION, Kanazawa-shi, Ishikawa (JP)

(72) Inventors: Takahiko KUROKAWA, Kanazawa-shi, Ishikawa (JP); Masami FUJIHARA, Komatsu-shi, Ishikawa (JP)

(73) Assignee: KOMATSU INDUSTRIES CORPORATION, Kanazawa-shi, Ishikawa (JP)

(21) Appl. No.: 16/486,858

(22) PCT Filed: Apr. 9, 2018
(86) PCT No.: PCT/JP2018/014904

§ 371 Date: Aug. 19, 2019

(30) Foreign Application Priority Data
Jul. 4, 2017 (JP) 2017-131271

(51) Int. Cl. B23Q 17/24; B21D 22/02; G05B 19/4063

(52) U.S. Cl. CPC B23Q 17/24; G05B 2219/34465; G05B 19/4063; B21D 22/02

(57) ABSTRACT

A machine system includes: a machine main body configured to process a workpiece, a camera configured to take a video of a processing process in which the workpiece is processed by the machine main body; and an information processing device that includes a memory and is configured to store, in the memory, video data acquired from the video taken by the camera. The information processing device is configured to protect, upon occurrence of abnormality in the processing process, the video data spanning a predetermined set period including a time of occurrence of the abnormality.

### TECHNICAL FIELD

The present disclosure relates to a machine system and a control method for the machine system.

### BACKGROUND ART

A variety of manufacturing machines (industrial machines) such as metal forming machine and machine tool have been known.

PTL 1 and PTL 2 each disclose a press machine as a kind of metal forming machine. The press machine of PTL 1 includes imaging means that captures images of a pierced portion of a workpiece. The press machine of PTL 2 includes a monitoring camera that captures images of a blind spot area for a control panel operated for controlling the press machine.

PTL 3 discloses a laser processing machine as a kind of machine tool. The laser processing machine includes a video camera. The video camera is positioned so that its angle of view covers a workpiece's area to be irradiated with a laser beam.

PTL 4 discloses a process monitoring device that monitors a process in a production line. The process monitoring device monitors a flow in which a transport robot conveys a workpiece on a transport path of the preceding process to a transport path of the following process, by capturing images of the flow. Upon receiving, from a detection device disposed in the production line, a trigger signal indicative of abnormality of the condition of workpiece(s) (intervals between workpieces, inclination of workpieces, for example) of the following process, the process monitoring device stores image data, as non-rewritable image data, which spans a set period or more in the past from the time when the trigger signal is input, out of image data recorded in a memory of the process monitoring device.

### CITATION LIST

### Patent Literature

PTL 1: Japanese Patent Laying-Open No. 2000-225423

PTL 2: Japanese Patent Laying-Open No. H08-224697

PTL 3: Japanese Patent Laying-Open No. 2001-018079

PTL 4: Japanese Patent Laying-Open No. 2016-122319

### SUMMARY OF INVENTION

### Technical Problem

For the machines disclosed in PTL 1 to PTL 3, it is impossible to check, at a later time, a video capturing occurrence of abnormality. For the device disclosed in PTL 4, it is impossible to check, at a later time, abnormality in a workpiece processing process by means of a video.

An object of the present disclosure is to provide a machine system and a control method for the machine system that enable abnormality in a workpiece processing process to be checked afterward.

### Solution to Problem

According to an aspect of the present disclosure, a machine system includes: a machine main body configured to process a workpiece; a camera configured to take a video of a processing process in which the workpiece is processed by the machine main body; and an information processing device including a memory and configured to store, in the memory, video data acquired from the video taken by the camera. The information processing device is configured to protect, upon occurrence of abnormality in the processing process, the video data spanning a predetermined set period including a time of occurrence of the abnormality.

### Advantageous Effects of Invention

According to the present disclosure, abnormality in a workpiece processing process can be checked afterward.

### BRIEF DESCRIPTION OF DRAWINGS

FIG. 1 shows a schematic configuration of a press system 1 according to the present embodiment.

FIG. 2 illustrates a relation of connection between devices constituting press system 1.

FIG. 3 illustrates transmission and reception of data in a system configuration shown in FIG. 2.

FIG. 4 shows an example hardware configuration of an information processing device.

FIG. 5 illustrates an overview of video data protection.

FIG. 6 illustrates an overview of operational information protection.

FIG. 7 shows an example data structure of data protected by an information processing device.

FIG. 8 illustrates a method for protecting data.

FIG. 9 is a flow diagram for illustrating a flow of processing in an information processing device.

FIG. 10 shows an example screen of a tablet terminal upon receiving a user's operation to reproduce data.

FIG. 11 is a Pareto chart showing the number of occurrences of abnormality and the cumulative percentage thereof for each type of abnormality.

FIG. 12 shows an example data table in which the cause of occurrence of abnormality is associated with details of an action to be taken for recovery from the abnormality and the cause and the action details are managed for each cause of occurrence.

FIG. 13 shows data about a press machine as shown on a tablet terminal.

FIG. 14 illustrates a modification of the method for protecting data.

FIG. 15 illustrates transmission and reception of data in a modification of the press system.

FIG. 16 is a perspective view of a laser processing machine.

FIG. 17 shows an inside of a machine room.

FIG. 18 shows data indicating a part of operational information.

### DESCRIPTION OF EMBODIMENTS

Embodiments are described hereinafter based on the drawings. It is intended originally that features of the embodiments may be combined appropriately for use. Further, some of the constituent elements may not be used in some cases.

In the following, in connection with a first embodiment, a press system having a press machine is described as an example of manufacturing machines (industrial machines), by way of example. In connection with a second embodiment, a laser processing machine is described as an example of manufacturing machines, by way of example. The manufacturing machines are not limited to press machine system and laser processing machine. For example, a manufacturing machine may be a system having a metal forming machine other than a press machine. A manufacturing machine may also be a machine tool other than a laser processing machine.

### First Embodiment

### A. System Configuration

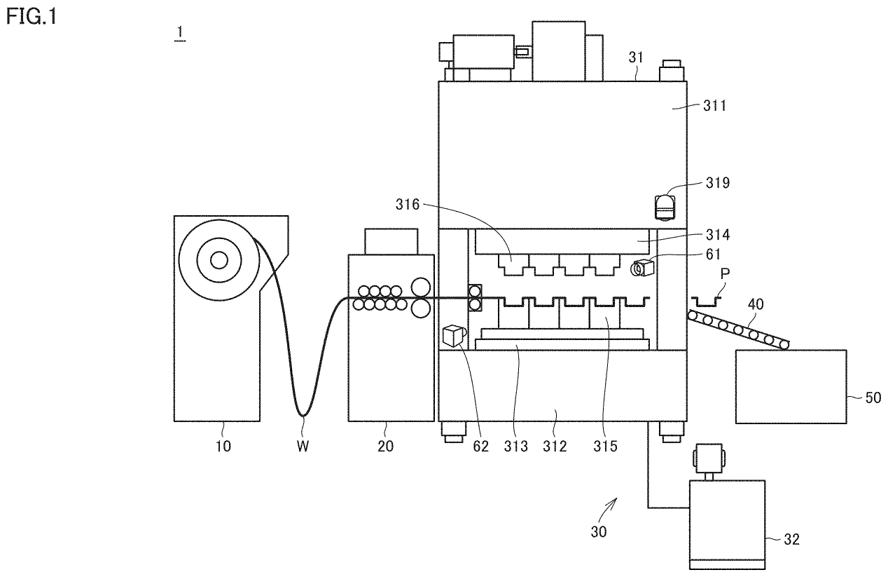

FIG. 1 shows a schematic configuration of a press system 1 according to the present embodiment.

As shown in FIG. 1, press system 1 includes a coil holder 10, a leveler feeder 20, a press machine 30, a transport conveyor 40, and cameras 61, 62. Press machine 30 includes a press machine main body 31 and a press controller 32. Press machine main body 31 includes a main body frame 311, a bed 312, a bolster 313, a slide 314, and a warning lamp 319.

A coil is wound around coil holder 10, and coil W is transported to press machine main body 31 through leveler feeder 20. In this example, a case is described in which coil W is pressed as a workpiece (material, member to be processed).

Leveler feeder 20 adjusts the height position at which a coil is transported from coil holder 10 to press machine main body 31, and transports coil W at a predetermined timing to press machine main body 31.

Substantially at a center of main body frame 311 of press machine main body 31, slide 314 is supported to be movable up and down. Bolster 313 mounted on bed 312 is disposed below slide 314. On the lower side of slide 314, an upper die 316 is mounted. On the upper side of bolster 313, a lower die 315 is mounted.

Press machine main body 31 presses coil W transported from leveler feeder 20, in accordance with a processing pattern. Press machine main body 31 positions coil W, which corresponds to a die made up of upper die 316 and lower die 315, on lower die 315 and thereafter causes upper die 316 to move down together with slide 314, to thereby press the coil.

Press controller 32 is a device controlling press machine main body 31. To press controller 32, various data required for controlling press machine main body 31 is entered, and press controller 32 has switches and ten keys used for entering data, as well as a display for presenting a setting screen and data that is output from press machine 30.

Press controller 32 is constituted of a CPU (Central Processing Unit), a high-speed numerical processor, and a memory or the like as main components, and includes a computer device performing arithmetic operation and logical operation on input data in accordance with a predetermined procedure, and an input/output interface through which command current is input and output.

The memory of press controller 32 includes an appropriate storage medium such as ROM (Read Only Memory), RAM (Random Access Memory), or the like. This memory stores a program for press controller 32 to implement various functions. The memory is also used as a work area for performing various arithmetic/logical operations.

Transport conveyor 40 transports, to a product box 50, a formed product that has been formed through pressing by press machine main body 31. This is not a limitation. Specifically, formed product P may be transported to a subsequent press machine by transport conveyor 40.

Warning lamp 319 is connected to press controller 32. Warning lamp 319 is configured to be lit, in response to occurrence of abnormality in press machine main body 31, based on a signal (bit indicative of the abnormality) sent from press controller 32. Warning lamp 319 flashes with red light in response to occurrence of abnormality in a processing process, for example. Examples of the abnormality include stoppage of operation of press machine main body 31, miss-feed of workpieces, for example.

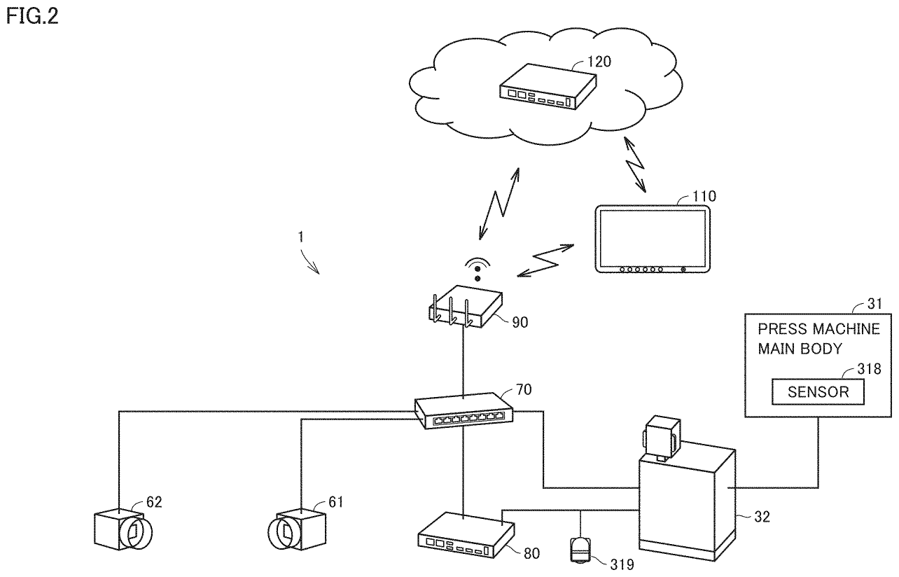

Cameras 61, 62 take a video of a processing process in which coil W (workpiece) is processed by press machine main body 31. Details are described later herein. Video data acquired from the video taken by cameras 61, 62 is stored in a memory of information processing device 80 (see FIG. 2).

Cameras 61, 62 are each a CCD (Charge Coupled Device) camera, for example. Camera 61 is disposed in an internal space (workpiece processing region) of press machine main body 31, for example. Camera 62 is disposed in an external space of press machine main body 31.

Camera 61 is disposed so that lower die 315 and upper die 316 are included within a view of the camera. Camera 61 can image the state of pressing by lower die 315 and upper die 316.

Camera 62 is disposed so that its view includes transported coil W and formed product P as well as warning lamp 319, in addition to lower die 315 and upper die 316.

In press system 1, camera 61 images details of the processing state, and camera 62 images the state of the entire pressing process.

The number of cameras of press system 1 is not limited to two. The locations of the cameras are not limited to those described above. The press system is preferably configured to enable the state of pressing by the dies to be imaged. The press system is also preferably configured to enable coil W before pressing and formed product P after pressing to be imaged. Further, the press system is preferably configured to enable warning lamp 319 to be imaged.

The constituent parts of press system 1 are synchronized with each other, and a series of steps are carried out successively. Coil W is transported from coil holder 10 to press machine main body 31 through leveler feeder 20. The coil is pressed by press machine main body 31, and the pressed workpiece (formed product P) is transported by transport conveyor 40. This series of steps are repeated.

The above-described configuration of press system 1 is an example, and the press system is not limited to this configuration.

FIG. 2 illustrates a relation of connection between devices constituting press system 1.

As shown in FIG. 2, press system 1 includes a hub 70, an information processing device 80, a wireless router 90, and a tablet terminal 110, in addition to cameras 61, 62, press machine main body 31, and press controller 32.

Hub 70 is a switching hub compatible with PoE (Power over Ethernet), for example.

Cameras 61, 62 are connected to be capable of communicating with information processing device 80 through hub 70. Information processing device 80 is connected to be capable of communicating with wireless router 90 through hub 70.

Press controller 32 is connected to information processing device 80 by two communication channels. Specifically, one communication channel includes hub 70 and the other does not include hub 70. Press controller 32 is further connected to warning lamp 319 through the communication channel that does not include hub 70.

Wireless router 90 is disposed for communication with devices outside press system 1. Press system 1 is configured to be capable of communicating with tablet terminal 110 and server device 120, for example, through wireless router 90.

Tablet terminal 110 can access information processing device 80 through wireless router 90. Tablet terminal 110 can access server device 120. A screen for example displayed on tablet terminal 110 is described later herein.

Press machine main body 31 is an example of “machine main body” in the present disclosure. Information processing device 80 or press controller 32 is an example of “information processing device” in the present disclosure. Press controller 32 is an example of “controller” in the present disclosure.

### B. Transmission and Reception of Data

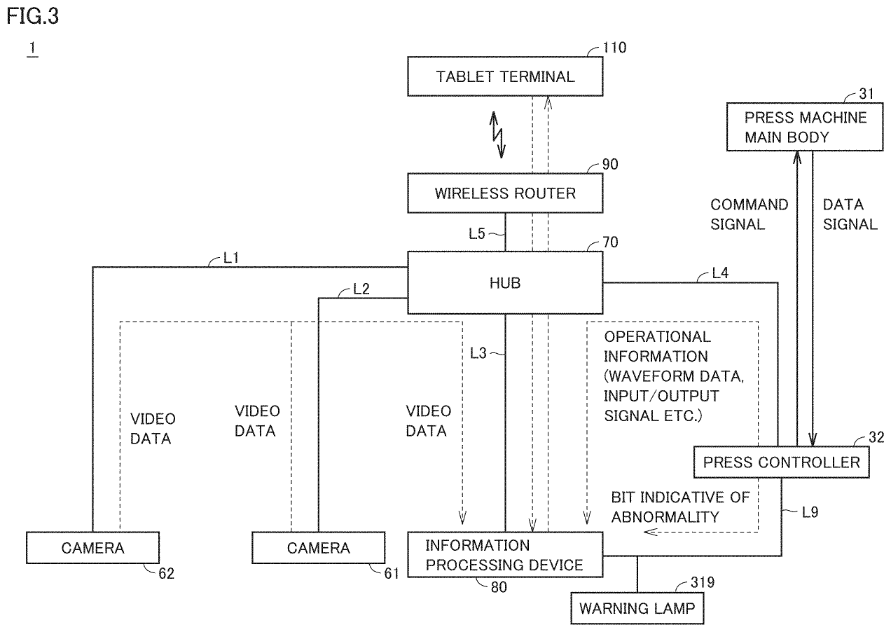

FIG. 3 illustrates transmission and reception of data in the system configuration shown in FIG. 2.

As shown in FIG. 3, camera 61 is in wired connection with hub 70 by a LAN (Local Area Network) cable L1. Likewise, camera 62 is in wired connection with hub 70 by a LAN cable L2. Information processing device 80 is also in wired connection with hub 70 by a LAN cable L3. Press controller 32 is in wired connection with hub 70 by a LAN cable L4. Wireless router 90 is in wired connection with hub 70 by a LAN cable L5. Typically, LAN cables L1 to L5 are each an Ethernet® cable.

Press controller 32 is connected to information processing device 80 and warning lamp 319 by an I/O (Input/Output) connection cable L9 having a high real time capability.

Cameras 61, 62 sequentially transmit, through hub 70 to information processing device 80, video data acquired by imaging. The video data is made up of a plurality of image frames. Each image frame includes a timestamp.

Press controller 32 uses LAN cables L3, L4 to sequentially transmit, through hub 70 to information processing device 80, operational information indicating the operational state of press machine main body 31. A part of the operational state is detected by a sensor 318 (see FIG. 2) disposed in press machine main body 31, for example.

The operational information is information associated with time. The operational information includes at least various waveform data, various input/output signal data (ON/OFF) signal, and basic information.

The operational information includes, as the waveform data, press waveform data and DC waveform data. The operational information includes, as the press waveform data, waveform data of a load applied from slide 314 to coil W, crank angle data, stroke length waveform data of slide 314, and the moving speed of slide 314, for example. The operational information includes, as the DC waveform data, power consumption and servo torque of press machine main body 31, for example. The operational information includes, as the basic information, information about the total operational time of press machine main body 31, information about the number of times press machine main body 31 has been in operation, information about the time elapsed from installation of press machine main body 31, and information about the operating ratio of press machine main body 31, for example.

Besides the aforementioned operational information, press controller 32 transmits, at a predetermined timing to information processing device 80, various information (hereinafter also referred to as “supplementary information”) such as press setting information, die information such as die number, process information such as process number, material information, and operator information, for example. Press controller 32 transmits these pieces of information to information processing device 80 before processing is started or when processing is started. The material information includes material quality information of coil W, thickness information of coil W, and size information of coil W, for example.

When abnormality occurs in press machine main body 31, press controller 32 uses I/O cable L9 to transmit a bit indicative of the abnormality to information processing device 80 and warning lamp 319 without hub 70 interposed therebetween.

The bit indicative of abnormality is thus transmitted by 110 connection cable L9 having a high real time capability, and therefore, the deviation between the timing at which press controller 32 transmits the bit and the timing at which information processing device 80 receives the bit is significantly small. In the following description, therefore, the time when information processing device 80 receives the bit indicative of abnormality is regarded as the time when the abnormality occurs.

Upon receiving the bit indicative of abnormality from press controller 32, information processing device 80 protects video data and operational information that span a predetermined set period (hereinafter referred to as “set period Ts”) including the time when the bit was received (the time when the abnormality occurred). Details are described later herein. Set period Ts may be 5 seconds immediately preceding the time when the abnormality occurred and 15 seconds immediately following the time when the abnormality occurred. A specific protection method is described later herein.

Information processing device 80 stores the time when it received the bit (the time when the abnormality occurred) as a timestamp. Information processing device 80 also protects the aforementioned supplementary information that spans the set period Ts.

Press controller 32 transmits the operational information including the waveform data for example to information processing device 80 through LAN cables L4, L3 and hub 70. Therefore, the operational information transmitted at the timing when press controller 32 transmitted the bit indicative of abnormality to information processing device 80 has not reached information processing device 80 at the timing when information processing device 80 receives the bit. Thus, the operational information reaches information processing device 80 with a delay relative to the bit indicative of abnormality. Accordingly, the operational information received by information processing device 80 at the timing when information processing device 80 receives the bit indicative of abnormality is the operational information immediately before the occurrence of the abnormality.

The same applies as well to the video data transmitted from cameras 61, 62. The video data received by information processing device 80 at the timing when information processing device 80 receives the bit indicative of abnormality is video data immediately before the occurrence of the abnormality.

Information processing device 80, however, can protect the operational information and the video data at the time of occurrence of the abnormality, by providing a sufficiently long protection period for the video data.

### BRIEF SUMMARY

As seen from the foregoing, press system 1 includes press machine main body 31 configured to process coil W which is a workpiece, cameras 61, 62 configured to take a video of a processing process in which coil W is processed by press machine main body 31, and information processing device 80 configured to store video data acquired from the video taken by cameras 61, 62.

In response to occurrence of abnormality in the processing process, information processing device 80 protects video data that spans a predetermined set period Ts including the time of occurrence of the abnormality. With this configuration, information processing device 80 protects the video data that spans a predetermined set period Ts including the time of occurrence of the abnormality, and therefore, the abnormality in the processing process of coil W as a workpiece can be checked afterward.

Moreover, in response to occurrence of abnormality in the processing process, information processing device 80 protects operational information that spans the predetermined set period Ts including the time of occurrence of the abnormality. With this configuration, information processing device 80 protects the operational information that spans the predetermined set period Ts including the time of occurrence of the abnormality, and therefore, the abnormality in the processing process of coil W as a workpiece can be checked afterward.

Press system 1 further includes press controller 32 configured to control operation of press machine main body 31. Press controller 32 is configured to detect occurrence of the abnormality and notify information processing device 80 of the occurrence of the abnormality. With this configuration, a device other than press controller 32 can protect the video data and the operational information that span a predetermined set period Ts including the time of occurrence of the abnormality.

### C. Hardware Configuration of Information Processing Device 80

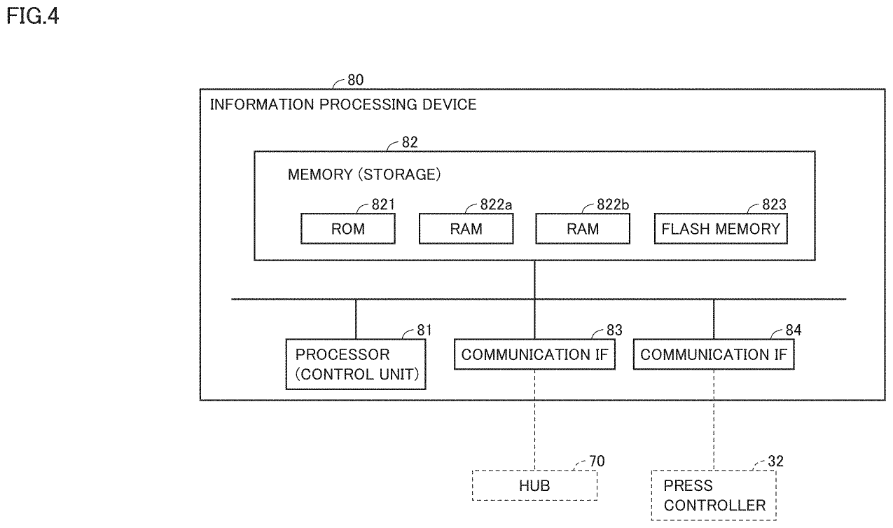

FIG. 4 shows an example hardware configuration of information processing device 80.

As shown in FIG. 4, information processing device 80 includes a processor 81, a memory 82, and communication IF (interfaces) 83, 84. Memory 82 includes, by way of example, a ROM (Read Only Memory) 821, RAM (Random Access Memories) 822a, 822b, and a flash memory 823. Memory 82 may include an HDD (Hard Disc Drive) instead of or in addition to flash memory 823.

Information processing device 80 may include a display. Press system 1 may be configured to show, on the display of information processing device 80, the contents shown on tablet terminal 110. The display of information processing device 80 and a display 111 of tablet terminal 110 are examples of “display” in the present disclosure.

Communication IF 83 is an interface for communicating with hub 70. Communication IF 84 is an interface for communicating with press controller 32.

Processor 81 executes an operating system and various programs that are stored in memory 82.

RAM 822a, 822b is a memory also referred to as cyclic memory. Processor 81 stores video data in RAM 822a. Processor 81 stores operational information in RAM 822b.

Processor 81 successively stores, in RAM 822a, video data acquired from a video taken by cameras 61, 62, in such a manner that overwrites the oldest data with the newest data when the free memory space of RAM 822a is insufficient. Typically, processor 81 divides the memory region of RAM 822a into two regions, stores video data acquired by camera 61 in one of the regions, and stores video data acquired by camera 62 in the other region.

Processor 81 also successively stores, in RAM 822b, operational information in such a manner that overwrites the oldest data with the newest data when the free memory space of RAM 822b is insufficient. Typically, processor 81 divides the memory region of RAM 822b into a plurality of regions, and stores different types of data included in the operational information in respective regions separately.

According to the foregoing, RAM 822a and RAM 822b are included. This is not a limitation. When processor 81 separately manages different regions in the memory space of a single RAM, processor 81 may include the single RAM only. Alternatively, different RAMs may be provided for respective types of data.

### D. How to Protect Data

d1. Data to be Protected

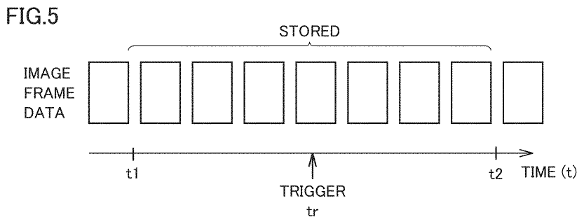

FIG. 5 illustrates an overview of video data protection.

As shown in FIG. 5, video data is made up of a plurality of image frame data.

Receiving a bit indicative of abnormality, information processing device 80 is triggered to protect video data that spans a predetermined set period Ts including time tr of reception of the bit. In the example in FIG. 5, the time of reception of the bit indicative of abnormality is time tr, and information processing device 80 protects the image frame data from time t1 earlier than tr to time t2 later than time tr. The length of time from time t1 to time t2 corresponds to the set period Ts.

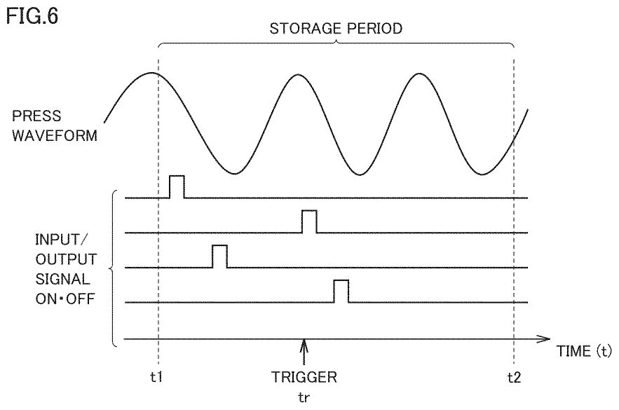

FIG. 6 illustrates an overview of operational information protection.

As shown in FIG. 6, operational information includes press waveform data and input/output signal data (ON/OFF signal). Receiving a bit indicative of abnormality, information processing device 80 is triggered to protect operational information that spans a predetermined set period Ts including time tr of reception of the bit. In the example in FIG. 6, information processing device 80 protects the operational information from time t1 earlier than time tr to time t2 later than time tr.

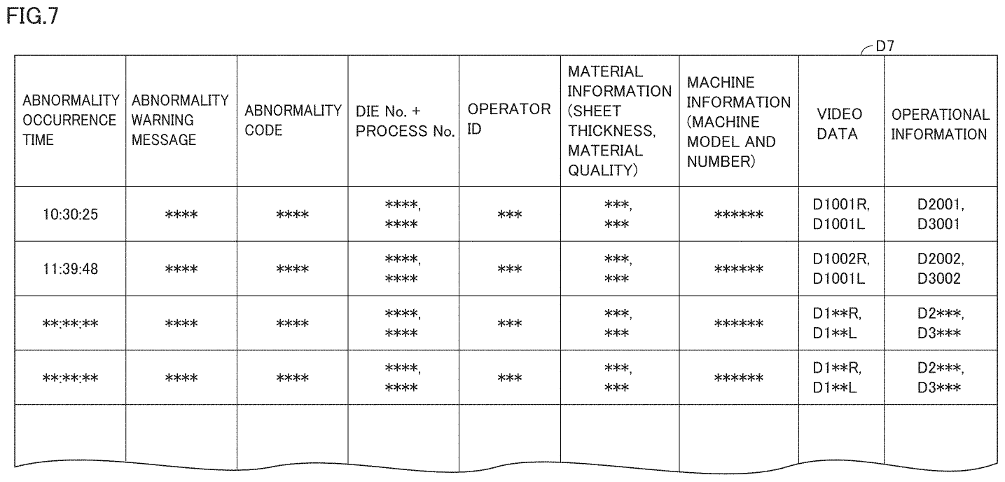

FIG. 7 shows an example data structure D7 of data protected by information processing device 80.

As shown in FIG. 7, information processing device 80 stores, by way of example, abnormality occurrence time, abnormality warning message, abnormality code, die number and process number, operator ID, material information, machine information, video data, and operational information that are associated with each other. These pieces of information are transmitted from press controller 32 to information processing device 80 and managed by information processing device 80.

The abnormality occurrence time is the time when information processing device 80 receives a bit indicative of abnormality from press controller 32, for example. The video data is managed for each of cameras 61, 62. The operational information is also managed for each of the press waveform data and the input/output signal data. Information processing device 80 may integrate the press waveform data and the input/output signal data into a single datum and manages the single datum. This is applied as well to the video data.

A user of the information processing device can use, as a search key, at least one of the abnormality occurrence time, the abnormality warning message, the abnormality code, the die number and process number, the operator ID, the material information, and the machine information, to thereby extract video data and operational information that are associated with the search key. In this way, the usability is improved.

d2. Protection Method

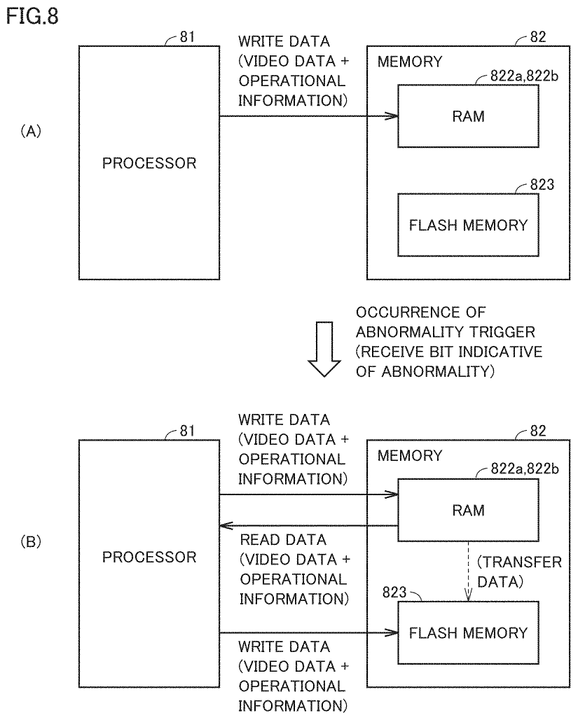

FIG. 8 illustrates a method for protecting data.

As shown in a state (A) of FIG. 8, processor 81 successively writes, in RAM 822a which is a cyclic memory, video data (image frame data) transmitted successively from cameras 61, 62 through hub 70. Processor 81 also successively writes, in RAM 822b which is a cyclic memory, operational information transmitted successively from press controller 32 through hub 70.

As shown in a state (B), upon receiving a bit indicative of abnormality from press controller 32, information processing device 80 reads, from RAM 822a, video data that spans a predetermined set period Ts including the time when information processing device 80 received the bit indicative of abnormality, and stores the read video data in flash memory 823. Likewise, information processing device 80 reads, from RAM 822b, operational information that spans the predetermined set period Ts including the time when information processing device 80 received the bit indicative of abnormality, and stores the read operational information in flash memory 823.

Flash memory 823 is a nonvolatile memory. Therefore, unless a user of information processing device 80 overwrites or erases the video data and the operational information, the video data and the operational information are kept stored in flash memory 823.

As seen from the foregoing, information processing device 80 transfers, to flash memory 823, the video data temporarily stored in RAM 822a, to thereby protect the video data spanning the set period Ts. Information processing device 80 also transfers, to flash memory 823, the operational information temporarily stored in RAM 822b, to thereby protect the operational information spanning the set period Ts.

RAM 822a and RAM 822b are examples of “first memory region” in the present disclosure. Flash memory 823 is an example of “second memory region” in the present disclosure.

### BRIEF SUMMARY

Memory 82 includes RAM 822a and flash memory 823 as described above. Information processing device 80 stores, in RAM 822a, video data acquired from a taken video, in such a manner that overwrites the oldest data with the newest data when the free memory space of RAM 822a is insufficient. Upon occurrence of abnormality, information processing device 80 stores, in flash memory 823, the video data spanning the set period Ts stored in RAM 822a to thereby protect the video data spanning the set period Ts.

Thus, the video data is stored in nonvolatile flash memory 823, and therefore, even when RAM 822a is thereafter overwritten, abnormality in a workpiece processing process can be checked afterward. Moreover, even when power feeding to information processing device 80 is stopped, the video data spanning the set period Ts including the time of occurrence of the abnormality is not lost. In addition, the memory capacity can be reduced.

### E. Control Structure

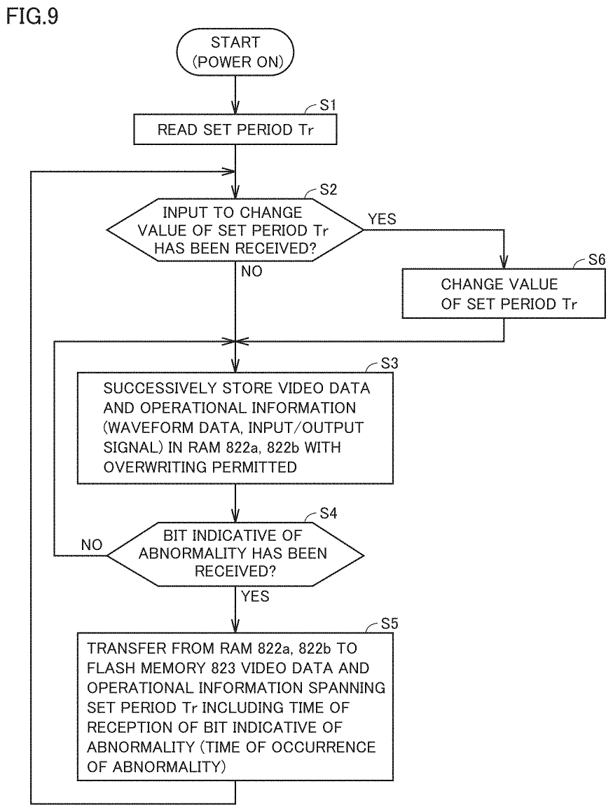

FIG. 9 is a flow diagram for illustrating a flow of a process in information processing device 80.

As shown in FIG. 9, in step S1, processor 81 of information processing device 80 reads a value of the set period Ts from memory 82. In step S2, processor 81 determines whether or not it has received an input to change the value of the set period Ts.

When processor 81 has received an input to change the value of the set period Ts (YES in step S2), processor 81 changes the value of the set period Ts in step S6. Information processing device 80 can change, not only the length of the set period Ts, but also the storage period immediately before the time of occurrence of abnormality and the storage period immediately after the time of occurrence of abnormality. After step S6, processor 81 proceeds to step S3.

When processor 81 has not received an input to change the value of the set period Ts (NO in step S2), processor 81 successively stores video data and operational information in RAM 822a, 822b with overwriting permitted, in step S3.

In step S4, processor 81 determines whether or not it has received a bit indicative of abnormality. When processor 81 determines that it has received a bit indicative of abnormality (YES in step S4), processor 81 transfers, from RAM 822a, 822b to flash memory 823, video data and operational information spanning the set period Ts including the time when it received the bit indicative of abnormality (the time of occurrence of the abnormality), in step S5. When processor 81 determines that it has not received a bit indicative of abnormality (NO in step S4), processor 81 proceeds to step S3.

After step S5, processor 81 proceeds to step S2.

### F. How to Use the Data

In the following, a description is given of a manner of using video data and operational information that are protected by being transferred to flash memory 823 by information processing device 80.

f1. Data Reproduction

Tablet terminal 110 can communicate with information processing device 80 through wireless router 90 and hub 70 as described above. Receiving a user's operation to reproduce data, tablet terminal 110 transmits a predetermined instruction to information processing device 80.

Tablet terminal 110 acquires, from information processing device 80, an abnormality warning message (see FIG. 7) indicating details of abnormality as well as video data and operational information spanning the set period Ts that are stored in flash memory 823, based on the transmission of the predetermined instruction.

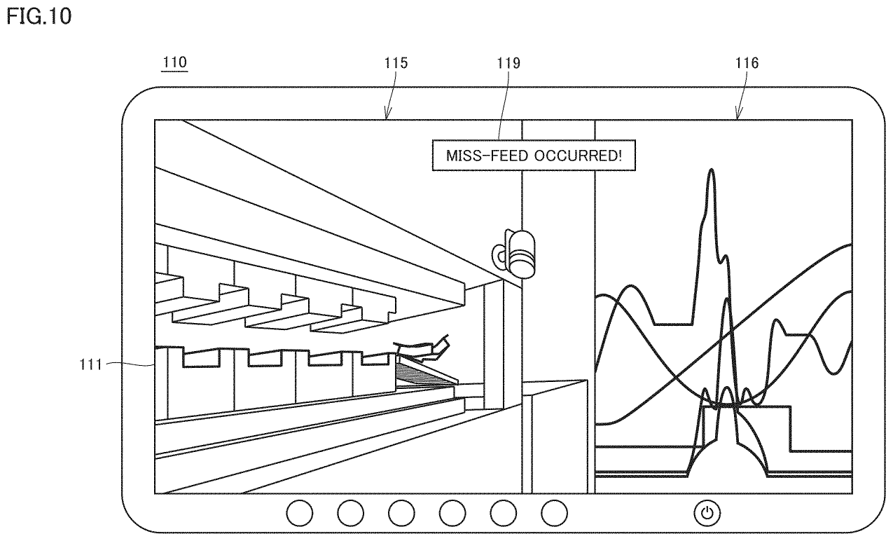

FIG. 10 shows an example screen of tablet terminal 110 upon receiving a user's operation to reproduce data. As shown in FIG. 10, tablet terminal 110 shows, on display 111, an abnormality warning message 119 associated with video data and operational information that span the set period Ts.

For example, tablet terminal 110 uses a display region 115 of display 111 to reproduce the video data, and uses a display region 116 different from display region 115 to reproduce the operational information. Further, tablet terminal 110 shows abnormality warning message 119 while the video data and the operational information are reproduced.

An image based on the video data successively changes in time sequence with passage of time, as the video data is reproduced. For example, tablet terminal 110 reproduces the video of a series of pressing steps for coil W. The image at a certain time shown in FIG. 10 shows a state where coil W that has not been pressed correctly is transported by transport conveyor 40.

Regarding an image based on the operational information, tablet terminal 110 may move waveforms with passage of time so that the waveforms appear to flow leftward on the screen. Alternatively, tablet terminal 110 may not move waveforms but move an object (vertical bar for example) indicting the position of a waveform at a time during reproduction, from left to right on the screen.

In any case, it is preferable for tablet terminal 110 to synchronize an image of the video data with an image of the operational information during data reproduction. In the following, how these images are synchronized with each other is described.

These data are typically synchronized with each other by information processing device 80 in advance.

By way of example, information processing device 80 synchronizes video data with operational information that span the set period Ts, with respect to the time when a bit indicative of abnormality is received. Specifically, information processing device 80 processes video data and operational information that are received at the timing when a bit indicative of abnormality is received from press controller 32, as data at the same timing on a time axis, to thereby synchronize the video data with the operational information that span the set period Ts.

Alternatively, information processing device 80 may synchronize video data with operational information that span the set period Ts by the following process.

Information processing device 80 determines, from video data, the timing at which warning lamp 319 was lit. With respect to the lit timing, information processing device 80 synchronizes the video data with the operational information that span the set period Ts. Specifically, information processing device 80 processes video data at the timing when warning lamp 319 was lit as acquired from the video data, and operational information received at this timing, as data at the same timing on a time axis, to thereby synchronize the video data with the operational information that span the set period Ts.

Further, information processing device 80 may synchronize video data with operational information that span the set period Ts, by the following process.

Information processing device 80 may use timestamps included in a plurality of image frames constituting video data as well as time information included in operational information to synchronize video data with operational information that span the set period Ts. Specifically, information processing device 80 may process an image frame having a timestamp representing the time when information processing device 80 received from press controller 32 a bit indicative of abnormality, and operational information at this time, as data at the same timing on a time axis, to thereby synchronize the video data with the operational information that span the set period Ts.

### BRIEF SUMMARY

(1) As seen from the foregoing, press system 1 further includes tablet terminal 110 having display 111. Tablet terminal 110 transmits a predetermined instruction to information processing device 80, upon receiving a predetermined user operation (user operation to reproduce data). Tablet terminal 110 acquires the video data spanning the set period Ts and the abnormality warning message from information processing device 80, based on the transmission of the instruction. As shown in FIG. 10, tablet terminal 110 shows, on display 111, abnormality warning message 119 associated with the video data spanning the set period Ts.

With this configuration, a user of tablet terminal 110 can check the video at the time of occurrence of the abnormality, together with details of the abnormality.

(2) Press system 1 further includes sensor 318 (see FIG. 2) that detects an operational state of press machine main body 31. Information processing device 80 causes the video data spanning the set period Ts to be shown on display 111, where the video data is associated further with the operational information which is a result of detection by sensor 318.

With this configuration, a user of tablet terminal 110 can check the video and the operational information at the time of occurrence of the abnormality, together with details of the abnormality.

(3) Press controller 32 detects occurrence of abnormality and notifies information processing device 80 of the occurrence of the abnormality. Information processing device 80 synchronizes the video data spanning the set period Ts with the operational information which is the result of the detection, with respect to the time when information processing device 80 is notified of the occurrence. On display 111 of tablet terminal 110, the video data and the operational information synchronized with each other are shown. With this configuration, a user of tablet terminal 110 can check the operational information at the time of visual recognition of the abnormality in the video.

Alternatively, information processing device 80 determines the timing at which warning lamp 319 was lit, from the video data spanning the set period Ts. With respect to the lit timing of warning lamp 319, information processing device 80 synchronizes the video data spanning the set period Ts with the operational information which is the result of detection. On display 111 of tablet terminal 110, the video data and the operational information that are synchronized with each other are shown. With this configuration, a user of tablet terminal 110 can check the operational information at the time of visual recognition of the abnormality in the video.

f2. Visualization of Cause

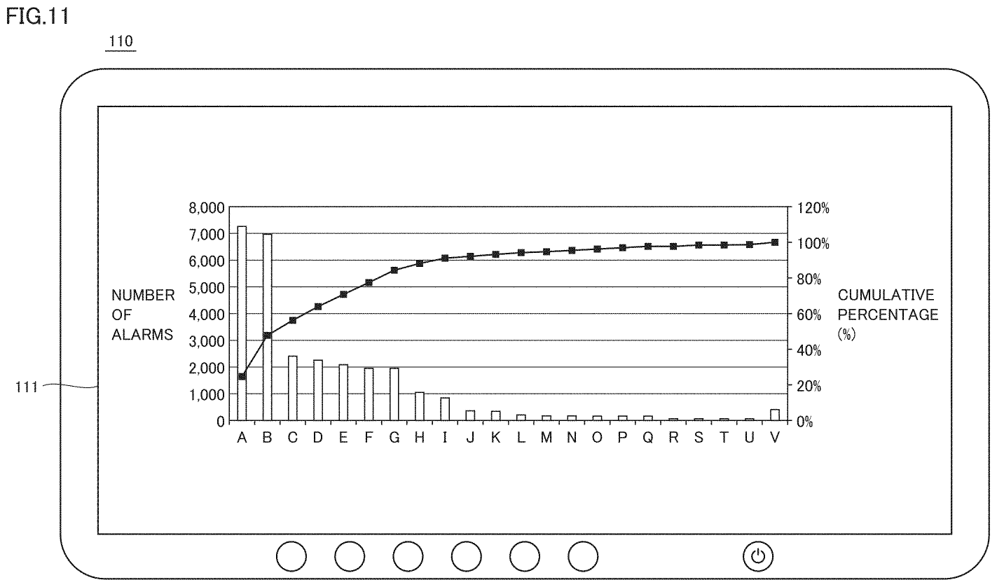

FIG. 11 is a Pareto chart showing the number of occurrences of abnormality (alarm) and the cumulative percentage thereof for each type of abnormality.

As shown in FIG. 11, tablet terminal 110 receives, from information processing device 80, data for showing a Pareto chart, and shows the Pareto chart on display 111. The horizontal axis (A, B, C, . . . ) of the Pareto chart represents types of abnormality.

Such a Pareto chart is prepared for each product die and for each product process. In each Pareto chart, the number of occurrences of miss-feed, for example, is plotted in the Pareto manner, for each type of miss-feed.

A user of tablet terminal 110 can know, from the Pareto chart, a die in which abnormality is likely to occur, and a process in which abnormality is likely to occur.

f3. Comments for Assisting in Recovery

Information processing device 80 has a function of presuming the cause of occurrence of abnormality. The cause of occurrence of abnormality may be presumed by press controller 32, tablet terminal 110, or server device 120.

Information processing device 80 stores a data table in which the cause of occurrence of abnormality is associated with details of an action to be taken for recovery from the abnormality, and the cause and the details are managed for each cause of occurrence. Alternatively, press controller 32, tablet terminal 110, or server device 120 may store this data table and information processing device 80 may use the data.

Thus, the device presuming the cause of abnormality and the device storing the data table are not particularly limited.

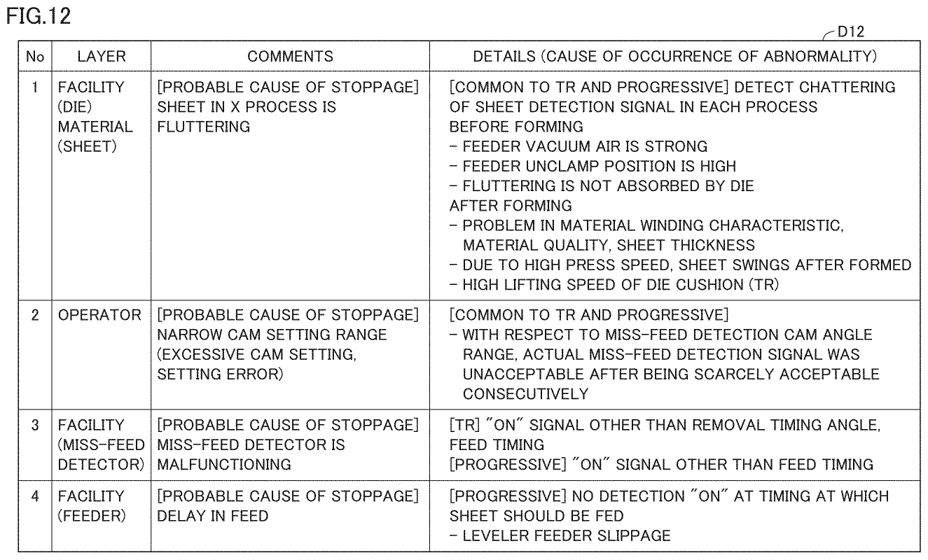

FIG. 12 shows an example data table in which the cause of occurrence of abnormality is associated with details of an action to be taken for recovery from the abnormality and the cause and the action details are managed for each cause of occurrence.

As shown in FIG. 12, ID number, layer, comments, and details (cause of occurrence of abnormality) associated with each other are stored in a data table D12. In the comments column, details of an action to be taken for abnormality are indicated. Specifically, in the comments column, assist information (support information) for recovery of press machine main body 31 from abnormality is indicated.

The assist information is information indicating a recovery procedure, for example. The recovery procedure is typically the same as the contents described in a recovery procedure (manual) written on a paper medium.

Based on the operational information, information processing device 80 presumes the cause of abnormality. Information processing device 80 presumes which of press machine main body 31, the die, coil W, leveler feeder 20, and transport conveyor 40 has a problem. Further, from data table D12, information processing device 80 extracts comments (details of action) associated with the presumed cause of occurrence of abnormality.

Receiving a predetermined instruction from tablet terminal 110, information processing device 80 transmits comments to tablet terminal 110. Receiving the comments, tablet terminal 110 shows the comments on display 111. Information processing device 80 may show the comments on its own display.

### BRIEF SUMMARY

As seen from the foregoing, information processing device 80 can access data table D12 in which the cause of occurrence of abnormality is associated with comments (action details) for recovery from abnormality, and the cause and the comments are managed for each cause of occurrence. Based on the operational information, information processing device 80 presumes the cause of occurrence of abnormality. Based on data table D12, information processing device 80 causes the comments associated with the presumed cause of occurrence of abnormality to be shown on the display.

With this configuration, a user can know a recovery action procedure or the like, without checking a manual or the like on a paper medium. A speedy and appropriate recovery action can therefore be carried out.

### Modification

Information processing device 80 may presume the cause of occurrence of abnormality, further using video data spanning the set period Ts.

Specifically, information processing device 80 analyzes the video data spanning the set period Ts. Based on the result of analysis, information processing device 80 further detects the operational state of press machine main body 31. Based on the operational information (result of detection by sensor 318, for example) and the result of detection based on the result of analysis, information processing device 80 presumes the cause of occurrence of the abnormality.

With this configuration, information processing device 80 can presume the cause of occurrence of the abnormality more accurately.

f4. Comparison with Other Devices

Press controller 32 or information processing device 80 transmits basic information included in the operational information to server device 120 through wireless router 90. The basic information includes, as described above, information about the total operating time of press machine main body 31, information about the number of times press machine main body 31 has been put into operation, information about the time elapsed from installation of press machine main body 31, and information about the operating ratio of press machine main body 31, for example.

Press controller 32 or information processing device 80 also transmits, to server device 120 through wireless router 90, the type of abnormality (abnormality code) and information about the number of occurrences of abnormality for each type.

Server device 120 acquires data about the machine such as the basic information, not only from press machine 30 but also other press machines of the same type as press machine 30. Server device 120 manages data acquired from a plurality of press machines and shows the performance level for example of press machine 30 as compared with other press machines.

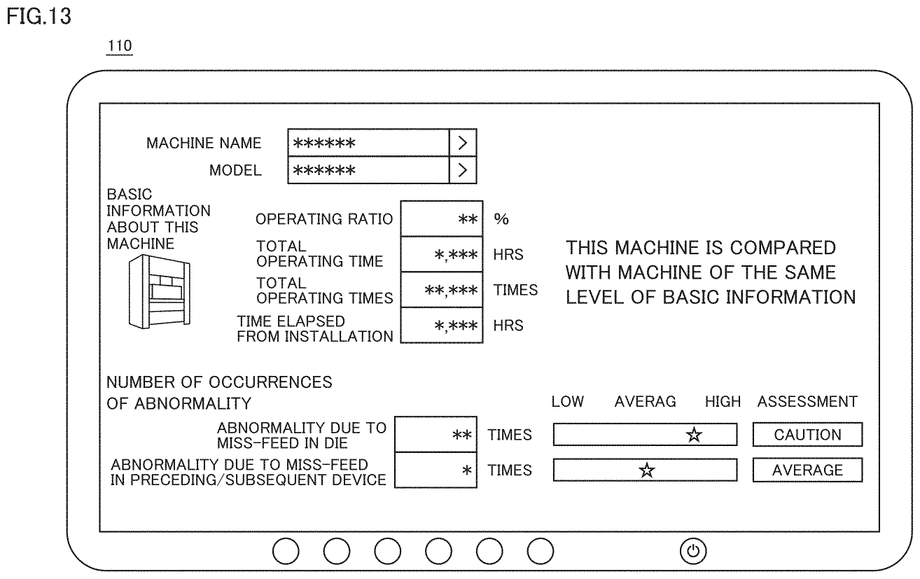

FIG. 13 shows data about press machine 30 as shown on tablet terminal 110.

As shown in FIG. 13, tablet terminal 110 shows the machine name, the model name, the operating ratio of press machine 30, the total operating time of press machine 30, the total number of times press machine 30 has been put into operation, the time elapsed from installation of press machine 30, and the number of times abnormality has occurred.

The item of the number of occurrences of abnormality includes the number of occurrences of miss-feed in the die, the number of occurrences of miss-feed in the preceding/subsequent device, information indicating the level as compared with another press machine in terms of the number of occurrences of miss-feed in the die, and information indicating the level as compared with another press machine in terms of the number of occurrences of miss-feed in the preceding/subsequent device. Instead of the number of occurrences, frequency information may be indicated.

Such information is shown on tablet terminal 110 to enable a user of press machine 30 to know the state of press machine 30 of the user as compared with press machines of others.

### G. Modification

g1. Protection Method

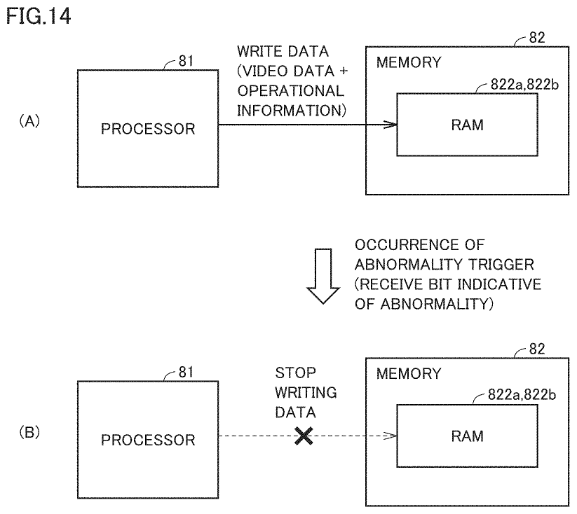

FIG. 14 illustrates a modification of the method for protecting data.

As shown in a state (A) of FIG. 14, processor 81 successively writes, in RAM 822a which is a cyclic memory, video data (image frame data) transmitted successively from cameras 61, 62 through hub 70. Processor 81 also successively writes, in RAM 822b which is a cyclic memory, operational information transmitted successively from press controller 32 through hub 70.

Upon receiving a bit indicative of abnormality from press controller 32, information processing device 80 stops writing the video data in RAM 822a as shown in a state (B). Likewise, information processing device 80 stops writing the operational information in RAM 822b.

As seen from the foregoing, in response to occurrence of abnormality, information processing device 80 stops overwriting RAM 822a, 822 with the video data to thereby protect the video data spanning the set period Ts.

g2. System Configuration

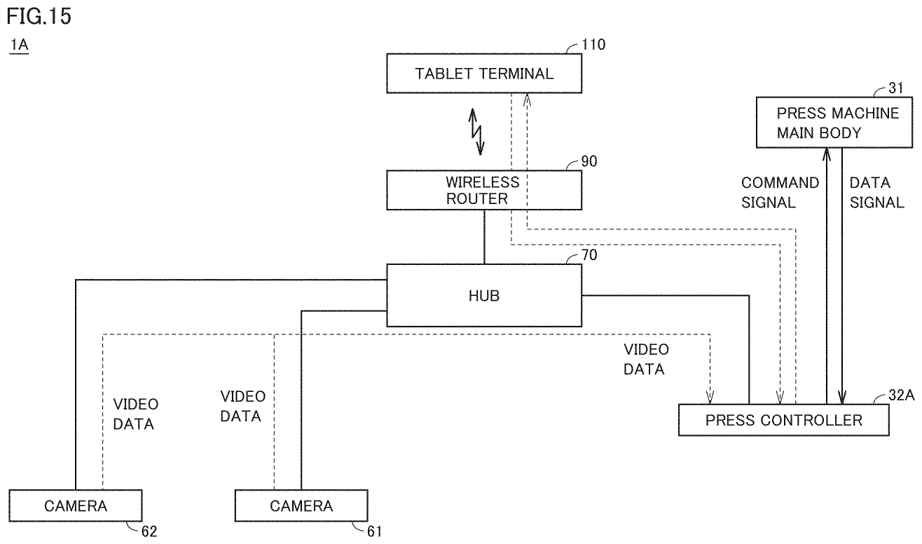

FIG. 15 illustrates transmission and reception of data in a press system 1A which is a modification of press system 1.

As shown in FIG. 15, press system 1A further includes cameras 61, 62, press machine main body 31, press controller 32, hub 70, wireless router 90, and tablet terminal 110. Press system 1A differs in configuration from press system 1 shown in FIG. 2 in that the former does not include information processing device 80. In press system 1A, a press controller 32 has the function of information processing device 80.

In press system 1A, video data acquired from imaging by cameras 61, 62 is transmitted sequentially to press controller 32 through hub 70. Press controller 32 in press system 1A is not required to transmit the operational information to hub 70, unlike press system 1.

Thus, press system 1A includes press machine main body 31 configured to process coil W as a workpiece, cameras 61, 62 configured to take a video of a processing process in which coil W is processed by press machine main body 31, and press controller 32 configured to store video data acquired from the video taken by cameras 61, 62. Upon occurrence of abnormality in the processing process, press controller 32 protects the video data that spans a predetermined set period Ts including the time of occurrence of the abnormality. With this configuration as well, the video data spanning the predetermined set period Ts including the time of occurrence of the abnormality is protected by press controller 32, and therefore, the abnormality in the processing process for coil W as a workpiece can be checked afterward.

In press system 1A, press controller 32 has the operational information by itself, and it is therefore unnecessary to establish synchronization with respect to the time when a bit indicative of abnormality is received and to establish synchronization with respect to the lit timing of warning lamp 319.

### Second Embodiment

In connection with the first embodiment, the above description is given of a press system including a press machine by way of example. In connection with the present embodiment, a description is given of a laser processing machine by way of example. In the following, differences from the first embodiment are mainly described.

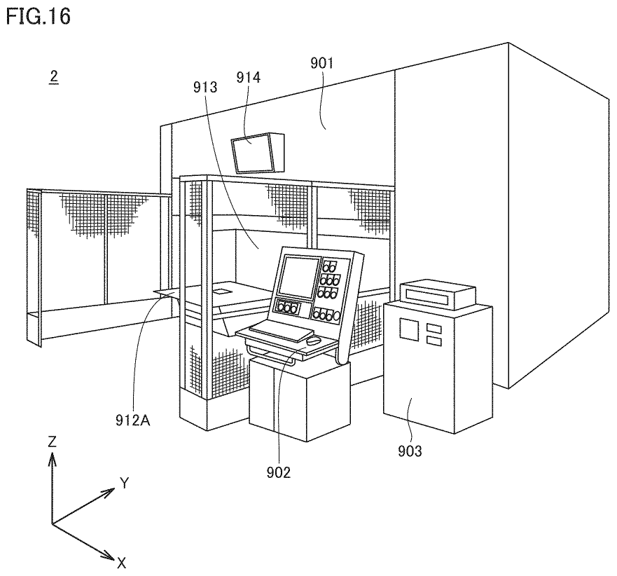

FIG. 16 is a perspective view of a laser processing machine 2.

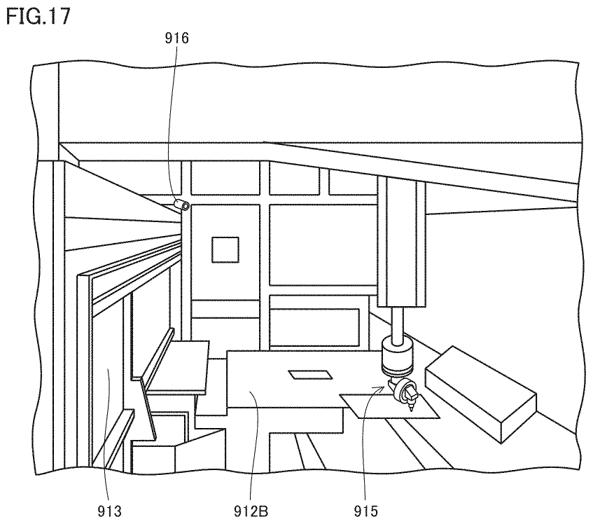

As shown in FIG. 16, laser processing machine 2 includes a processing machine main body 915 (see FIG. 17), a table 912A, a processing machine controller 902, and a laser generator 903. Processing machine main body 915 is disposed inside a machine room 901. Processing machine controller 902 and laser generator 903 are disposed outside machine room 901.

Laser processing machine 2 is a fiber laser processing machine by way of example. Processing machine main body 915 is a 5-axis (X axis, Y axis, Z axis, C axis, A axis) 3D laser processing machine by way of example. Laser processing machine 2 can be used to cut a workpiece into a desired shape.

On a wall surface of machine room 901, a monitor 914 is disposed for showing an image of the inside of machine room 901. Machine room 901 includes a pivoted door 913 pivoted about a pivot axis extending in parallel with the Z axis, and table 912A and a table 912B (see FIG. 17) pivotally moved in synchronization with pivoting of pivoted door 913. Pivoted door 913 is pivoted to cause table 912 to move into machine room 901.

Processing machine controller 902 is connected to processing machine main body 915, a driver (not shown) that pivotally drives tables 912A, 912B, and laser generator 903. Processing machine controller 902 controls operation of processing machine main body 915, operation of table 300, and operation of laser generator 903.

In accordance with a command from processing machine controller 902, laser generator 903 generates a laser beam. The generated laser beam is transmitted to processing machine main body 915 through an optical fiber.

A workpiece (object to be processed, member to be processed) is mounted on a table 300. Table 300 is moved into and out of the machine room in accordance with a command from processing machine controller 902.

Processing machine main body 915 is an example of “machine main body” in the present disclosure. Processing machine controller 902 is an example of “information processing device” in the present disclosure. Processing machine controller 902 is also an example of “controller” in the present disclosure.

FIG. 17 shows an inside of machine room 901.

As shown in FIG. 17, on a wall surface inside machine room 901, a camera 916 is attached. Camera 916 takes a video of a processing process in which a workpiece (not shown) is processed by processing machine main body 915. Video data acquired from the video taken by camera 916 is stored in a memory of processing machine controller 902. Camera 916 is a CCD camera, for example. The number of cameras of laser processing machine 2 is not limited to one.

Processing machine controller 902 has a similar function to that of information processing device 80 described above in connection with the first embodiment. Processing machine controller 902 includes processor 81 and memory 82.

Processing machine controller 902 protects the video data that spans a predetermined set period Ts including the time of occurrence of abnormality, in a similar manner to the first embodiment.

Specifically, laser processing machine 2 includes processing machine main body 915 configured to process a workpiece, camera 916 configured to take a video of a processing process in which the workpiece is processed by processing machine main body 915, and processing machine controller 902 configured to store video data acquired from the video taken by camera 916. Upon occurrence of abnormality in the processing process, processing machine controller 902 protects the video data spanning the predetermined set period Ts including the time of occurrence of the abnormality.

With this configuration, the video data spanning the predetermined set period Ts including the time of occurrence of the abnormality is protected, and therefore, abnormality in the workpiece processing process can be checked afterward.

Moreover, processing machine controller 902 protects the video data spanning the predetermined set period Ts including the time of occurrence of the abnormality, in a similar manner to the first embodiment. Operational information includes waveform data. Since the machine in the present embodiment is a laser processing machine, contents of the operational information in the present embodiment are not identical to those of the operational information of the press machine in the first embodiment.

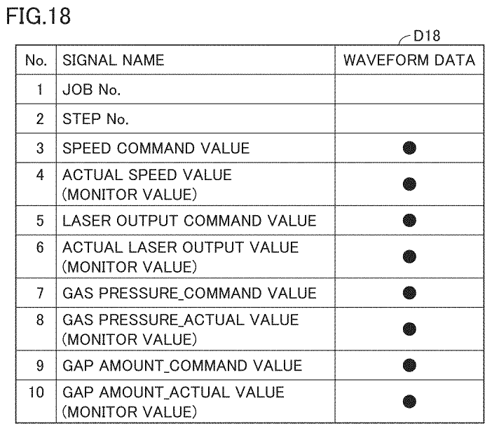

FIG. 18 shows data D18 indicating a part of the operational information. As shown in FIG. 18, processing machine controller 902 stores signals each associated with a respective number, as the operational information. Of these signals, the signals from No. 3 to No. 10 are waveform data.

The method for protecting the video data and the method for protecting the operational information are identical to the methods described above in connection with the first embodiment, and therefore, the description thereof is not herein repeated.

In press system 1 in the first embodiment, the video data and the operational information are reproduced on tablet terminal 110. In the present embodiment, the video data and the operational information are reproduced on processing machine controller 902 instead of tablet terminal 110. In a configuration in which laser processing machine 2 can communicate with a terminal device (not shown), the video data and the operational information may be reproduced on the terminal device.

Because processing machine main body 915 is located in machine room 901, the operation of processing machine main body 915 can be observed only through monitor 914. For laser processing machine 2, therefore, operational information such as power, cutting speed, and cutting height is displayed simultaneously with an image at the time, to thereby enable the cause of abnormality in cutting to be identified and the cutting quality to be improved. Moreover, the responsibility for the abnormality can be identified.

It should be construed that embodiments disclosed herein are given by way of illustration in all respects, not limited to the foregoing details only. It is intended that the scope of the present invention is defined by claims, and encompasses all modifications and variations equivalent in meaning and scope to the claims.

### REFERENCE SIGNS LIST

1, 1A press system; 2 laser processing machine; 10 coil holder; 20 leveler feeder; 30 press machine; 31 press machine main body; 32 press controller; 40 transport conveyor; 50 product box; 61, 62, 916 camera; 70 hub; 80 information processing device; 81 processor; 82 memory; 90 wireless router; 110 tablet terminal; 111 display; 115, 116 display region; 119 abnormality warning message; 120 server device; 300, 912, 912A, 912B table; 311 main body frame; 312 bed; 313 bolster; 314 slide; 315 lower die; 316 upper die; 318 sensor; 319 warning lamp; 822, 822a, 822b RAM; 823 flash memory; 901 machine room; 902 processing machine controller; 903 laser generator; 913 pivoted door; 914 monitor; 915 processing machine main body; L1, L2, L3, L4, L5 cable; L9 connection cable; P formed product; W coil

1. A machine system comprising:
a machine main body configured to process a workpiece;
a camera configured to take a video of a processing process in which the workpiece is processed by the machine main body; and
an information processing device including a memory and configured to store, in the memory, video data acquired from the video taken by the camera,
the information processing device being configured to protect, upon occurrence of abnormality in the processing process, the video data spanning a predetermined set period including a time of occurrence of the abnormality.

2. The machine system according to claim 1, further comprising a controller configured to control operation of the machine main body, wherein
the controller is configured to detect occurrence of the abnormality and notify the information processing device of occurrence of the abnormality.

3. The machine system according to claim 1, wherein the information processing device is a controller configured to control operation of the machine main body and detect occurrence of the abnormality.

4. The machine system according to claim 1, wherein
the memory includes a first memory region and a second memory region, and
the information processing device is configured to
store, in the first memory region, the video data acquired from the taken video, in a manner that overwrites oldest data with newest data when a free memory space is insufficient, and
store, in the second memory region, the video data spanning the set period and stored in the first memory region, to protect the video data spanning the set period, upon occurrence of the abnormality.

5. The machine system according to claim 1, wherein
the information processing device is configured to
store, in the memory, the video data acquired from the taken video, in a manner that overwrites oldest data with newest data when a free memory space is insufficient, and
stop overwriting the memory with the video data to protect the video data spanning the set period, upon occurrence of the abnormality.

6. The machine system according to claim 1, further comprising a display, wherein
the information processing device is configured to cause the display, upon receiving a predetermined instruction, to show the video data spanning the set period and associated with a message indicating details of the abnormality.

7. The machine system according to claim 6, further comprising a terminal device including the display, wherein
the terminal device is configured to
transmit the predetermined instruction to the information processing device, upon receiving a predetermined operation,
acquire the video data spanning the set period and the message from the information processing device, based on transmission of the predetermined instruction, and
show, on the display, the message associated with the video data spanning the set period.

8. The machine system according to claim 6, further comprising a sensor configured to detect an operational state of the machine main body, wherein
the information processing device is configured to
further protect a result of detection by the sensor that spans the set period, upon occurrence of abnormality in the processing process, and
cause the display to show the video data spanning the set period and associated with the result of detection by the sensor.

9. The machine system according to claim 8, wherein
the information processing device has access to data in which a cause of occurrence of the abnormality is associated with details of an action to be taken for recovery from the abnormality, the data being managed for each cause of occurrence of abnormality,
the information processing device is configured to presume a cause of occurrence of the abnormality based on the result of detection, and
the information processing device is configured to cause the display to show the details of the action associated with the presumed cause of occurrence of the abnormality, based on the data.

10. The machine system according to claim 9, wherein
the information processing device is configured to
conduct analysis of the video data spanning the set period,
further detect an operational state of the machine main body based on a result of the analysis, and
presume a cause of occurrence of the abnormality, based on
the result of detection by the sensor and
a result of detection based on the result of the analysis.

11. The machine system according to claim 8, further comprising a controller configured to control operation of the machine main body, wherein
the controller is configured to detect occurrence of the abnormality and notify the information processing device of occurrence of the abnormality,
the information processing device is configured to synchronize the video data spanning the set period with the result of detection, with respect to a time when the information processing device is notified of occurrence of the abnormality, and
the display is configured to show the video data and the result of detection synchronized with each other.

12. The machine system according to claim 8, further comprising:
a warning lamp located within a view of the camera, the warning lamp being configured to give a notification of occurrence of the abnormality; and
a controller configured to control operation of the machine main body, wherein
the controller is configured to detect occurrence of the abnormality and notify the information processing device of occurrence of the abnormality,
the information processing device is configured to
determine a timing at which the warning lamp is lit, based on the video data, and
synchronize the video data spanning the set period with the result of detection, with respect to the timing at which the warning lamp is lit, and
the display is configured to show the video data and the result of detection synchronized with each other.

13. The machine system according to claim 8, wherein
the machine main body is a press machine configured to press the workpiece by reciprocation of a slide, and
the result of detection is at least one of waveform data of a load applied from the slide to the workpiece and waveform data of a stroke length of the slide.

14. The machine system according to claim 1, wherein the abnormality is stoppage of operation of the machine main body.

15. The machine system according to claim 1, wherein the abnormality is miss-feed of the workpiece.

16. A control method comprising:
taking a video of a processing process in which a workpiece is processed, by a camera, and storing, in a memory, video data acquired from the video taken by the camera;
detecting occurrence of abnormality in the processing process; and
protecting the video data spanning a predetermined set period including a time of occurrence of the abnormality.
